(19) United States
(12) Patent Application Publication
(10) Pub. No.: US 2022/0225154 A1
(43) Pub. Date: Jul. 14, 2022

(54) VEHICLE-TO-EVERYTHING TRAFFIC LOAD CONTROL

(71) Applicant: Qualcomm incorporated, San Diego, CA (US)

(72) Inventors: Shuping CHEN, Beijing (CN); Yan LI, Beijing (CN); Lu GAO, Beijing (CN)

(21) Appl. No.: 17/612,239

(22) PCT Filed: May 28, 2020
(86) PCT No.: PCT/CN2020/092794

§ 371 Date: Nov. 18, 2021

(30) Foreign Application Priority Data
May 31, 2019 (CN) PCT/CN2019/089482

(51) Int. Cl. H04W 28/02

(52) U.S. Cl. CPC H04W 28/0268; H04W 4/40

(57) ABSTRACT

Methods, systems, and devices for wireless communications are described. A user equipment (UE) may receive a channel occupancy ratio for each of one or more proximity service priority levels. The UE may identify a resource availability metric and a message requirement metric for each of the one or more proximity service priority levels, the second protocol layer being a higher layer than the first protocol layer. The UE may determine a message generation rate for each of the one or more proximity service priority levels based on the channel occupancy ratio, or the resource availability metric, or the message requirement metric, or a combination thereof. The UE may generate one or more messages for each of the one or more proximity service priority levels based on the message generation rate.

### CROSS-REFERENCE TO RELATED APPLICATIONS

The present Application is a 371 national phase filing of International Patent Application No. PCT/CN2020/092794 by Chen et al., entitled “VEHICLE-TO-EVERYTHING TRAFFIC LOAD CONTROL,” filed May 28, 2020, and claims priority to PCT Application No. PCT/CN2019/089482 by Chen et al., entitled “VEHICLE-TO-EVERYTHING TRAFFIC LOAD CONTROL,” filed May 31, 2019, each of which is assigned to the assignee hereof, and each of which is expressly incorporated by reference in its entirety herein.

### BACKGROUND

The following relates generally to wireless communications, and more specifically to vehicle-to-everything (V2X) traffic load control.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Wireless communication systems may include or support networks used for vehicle-based communications, also referred to as V2X networks, vehicle-to-vehicle (V2V) networks, cellular V2X (CV2X) networks, or other similar networks. Vehicle-based communication networks may provide always-on telematics where UEs, e.g., vehicle UEs (v-UEs), communicate directly to the network (V2N), to pedestrian UEs (V2P), to infrastructure devices (V2I), and to other v-UEs (e.g., via the network and/or directly). The vehicle-based communication networks may support a safe, always-connected driving experience by providing intelligent connectivity where traffic signals/timing, real-time traffic and routing, safety alerts to pedestrians/bicyclist, collision avoidance information, etc., are exchanged. In some examples, communications in vehicle-based networks may include safety message transmissions (e.g., basic safety message (BSM) transmissions, traffic information message (TIM), etc.).

### SUMMARY

The described techniques relate to improved methods, systems, devices, and apparatuses that support vehicle-to-everything (V2X) traffic load control. Generally, the described techniques provide various solutions for controlling the generation of the traffic amount within the V2X network. Some aspects of the described techniques may be implemented in a cellular V2X (CV2X) network. Some aspects of the described techniques may include input from the access layer with respect to the congestion level being used to control a message generation rate by an upper layer. Other aspects of the described techniques may include the access layer managing the message generation rate. For example, an upper layer (e.g., a second protocol layer) of a user equipment (UE) may receive or otherwise determine a channel occupancy ratio for each proximity service priority level, e.g., a proximity service (ProSe) per-packet priority (PPPP) level, from an access layer (e.g., a first protocol layer of the UE). In some aspects, the upper layer may identify the available resources as well as the message requirements for each proximity service priority level message and use this information to determine the message generation rate. That is, the UE may use the channel occupancy ratio from the access layer in combination with the resource availability/message requirements to determine the message generation rate. The UE may generate one or more messages for the proximity service priority levels according to the message generation rate.

In another aspect, the access layer may modify one or more features associated with the message generation to manage aspects of the traffic congestion level. For example, the UE may determine or otherwise identify the transmission periodicity for message(s) of a proximity service priority level, e.g., a PPPP. The UE may identify a density metric, a node traffic pattern, and, for each node of a plurality of nodes, the node type. In some aspects, the UE may determine this information for not just other UEs, but for other nodes participating in the CV2X network, e.g., roadside unit (RSU) nodes, vulnerable road user (VRU) nodes, etc. The UE may use this information to modify the transmission periodicity for the one or more messages to manage the traffic congestion level within the CV2X network.

A method of wireless communication at a UE is described. The method may include receiving, from a first protocol layer of the UE, a channel occupancy ratio for each of one or more proximity service priority levels, identifying, by a second protocol layer of the UE, a resource availability metric and a message requirement metric for each of the one or more proximity service priority levels, the second protocol layer being a higher layer than the first protocol layer, determining, by the second protocol layer of the UE, a message generation rate for each of the one or more proximity service priority levels based on the channel occupancy ratio, or the resource availability metric, or the message requirement metric, or a combination thereof, and generating one or more messages for each of the one or more proximity service priority levels based on the message generation rate.

An apparatus for wireless communication at a UE is described. The apparatus may include a processor, memory coupled with the processor, and instructions stored in the memory. The instructions may be executable by the processor to cause the apparatus to receive, from a first protocol layer of the UE, a channel occupancy ratio for each of one or more proximity service priority levels, identify, by a second protocol layer of the UE, a resource availability metric and a message requirement metric for each of the one or more proximity service priority levels, the second protocol layer being a higher layer than the first protocol layer, determine, by the second protocol layer of the UE, a message generation rate for each of the one or more proximity service priority levels based on the channel occupancy ratio, or the resource availability metric, or the message requirement metric, or a combination thereof, and generate one or more messages for each of the one or more proximity service priority levels based on the message generation rate.

Another apparatus for wireless communication at a UE is described. The apparatus may include means for receiving, from a first protocol layer of the UE, a channel occupancy ratio for each of one or more proximity service priority levels, identifying, by a second protocol layer of the UE, a resource availability metric and a message requirement metric for each of the one or more proximity service priority levels, the second protocol layer being a higher layer than the first protocol layer, determining, by the second protocol layer of the UE, a message generation rate for each of the one or more proximity service priority levels based on the channel occupancy ratio, or the resource availability metric, or the message requirement metric, or a combination thereof, and generating one or more messages for each of the one or more proximity service priority levels based on the message generation rate.

A non-transitory computer-readable medium storing code for wireless communication at a UE is described. The code may include instructions executable by a processor to receive, from a first protocol layer of the UE, a channel occupancy ratio for each of one or more proximity service priority levels, identify, by a second protocol layer of the UE, a resource availability metric and a message requirement metric for each of the one or more proximity service priority levels, the second protocol layer being a higher layer than the first protocol layer, determine, by the second protocol layer of the UE, a message generation rate for each of the one or more proximity service priority levels based on the channel occupancy ratio, or the resource availability metric, or the message requirement metric, or a combination thereof, and generate one or more messages for each of the one or more proximity service priority levels based on the message generation rate.

Some examples of the method, apparatuses, and non-transitory computer-readable medium described herein may further include operations, features, means, or instructions for determining that the message generation rate satisfies a threshold value, where the one or more messages may be generated based on the message generation rate satisfying the threshold value.

Some examples of the method, apparatuses, and non-transitory computer-readable medium described herein may further include operations, features, means, or instructions for determining that the message generation rate fails to satisfy a threshold value, and recalculating the message generation rate based on a random number, where the one or more messages may be generated based on the recalculated message generation rate.

Some examples of the method, apparatuses, and non-transitory computer-readable medium described herein may further include operations, features, means, or instructions for identifying, based on the message requirement metric, a transmission periodicity of the one or more messages, and modifying the transmission periodicity based on the message generation rate.

Some examples of the method, apparatuses, and non-transitory computer-readable medium described herein may further include operations, features, means, or instructions for transmitting the one or more messages based on the modified transmission periodicity.

Some examples of the method, apparatuses, and non-transitory computer-readable medium described herein may further include operations, features, means, or instructions for determining that a critical event trigger may have occurred, and generating and transmitting the one or more messages in response to the occurrence of the critical event trigger.

In some examples of the method, apparatuses, and non-transitory computer-readable medium described herein, identifying the resource availability metric may include operations, features, means, or instructions for identifying a number of subcarriers available for communicating the one or more messages within a control time period.

In some examples of the method, apparatuses, and non-transitory computer-readable medium described herein, identifying the message requirement metric may include operations, features, means, or instructions for identifying a number of subcarriers required for communicating the one or more messages, or a modulation and coding scheme for the one or more messages, or a repetition factor for each of the one or more messages, or a transmission periodicity of the one or more messages, or a combination thereof

A method of wireless communication at a UE is described. The method may include identifying a transmission periodicity of one or more messages of a proximity service priority level, identifying, for a set of nodes, a node density metric and a node traffic pattern, identifying, for each node of the set of nodes, a node type, and modifying the transmission periodicity for the one or more messages based on the node density metric, or the node traffic pattern, or the node type for each node of the set of nodes, or a combination thereof

An apparatus for wireless communication at a UE is described. The apparatus may include a processor, memory coupled with the processor, and instructions stored in the memory. The instructions may be executable by the processor to cause the apparatus to identify a transmission periodicity of one or more messages of a proximity service priority level, identify, for a set of nodes, a node density metric and a node traffic pattern, identify, for each node of the set of nodes, a node type, and modify the transmission periodicity for the one or more messages based on the node density metric, or the node traffic pattern, or the node type for each node of the set of nodes, or a combination thereof.

Another apparatus for wireless communication at a UE is described. The apparatus may include means for identifying a transmission periodicity of one or more messages of a proximity service priority level, identifying, for a set of nodes, a node density metric and a node traffic pattern, identifying, for each node of the set of nodes, a node type, and modifying the transmission periodicity for the one or more messages based on the node density metric, or the node traffic pattern, or the node type for each node of the set of nodes, or a combination thereof.

A non-transitory computer-readable medium storing code for wireless communication at a UE is described. The code may include instructions executable by a processor to identify a transmission periodicity of one or more messages of a proximity service priority level, identify, for a set of nodes, a node density metric and a node traffic pattern, identify, for each node of the set of nodes, a node type, and modify the transmission periodicity for the one or more messages based on the node density metric, or the node traffic pattern, or the node type for each node of the set of nodes, or a combination thereof.

Some examples of the method, apparatuses, and non-transitory computer-readable medium described herein may further include operations, features, means, or instructions for determining, based on the node type, an available transmission power for each node of the set of nodes, where the modified transmission periodicity may be based on the available transmission power for each node.

Some examples of the method, apparatuses, and non-transitory computer-readable medium described herein may further include operations, features, means, or instructions for determining that a critical event trigger may have occurred, and generating and transmitting the one or more messages in response to the occurrence of the critical event trigger.

In some examples of the method, apparatuses, and non-transitory computer-readable medium described herein, the node density metric may be based on a number of nodes within a proximity range of the UE.

In some examples of the method, apparatuses, and non-transitory computer-readable medium described herein, the node type includes at least one of a neighboring UE, or a roadside unit, or a vulnerable road user, or a combination thereof

In some examples of the method, apparatuses, and non-transitory computer-readable medium described herein, modifying the transmission periodicity further includes determining the node density metric, or the node traffic pattern, or the node type for each node of the plurality of nodes, or a combination thereof satisfies a threshold condition, and determining the transmission periodicity is one of a maximum transmission periodicity, a round function applied to a value, or 100 milliseconds based on determining the node density metric, or the node traffic pattern, or the node type for each node of the plurality of nodes, or a combination thereof satisfies the threshold condition, wherein the value is based at least in part on the node density metric, or the node traffic pattern, or the node type for each node of the plurality of nodes, or a combination thereof.

### BRIEF DESCRIPTION OF THE DRAWINGS

FIG. 1 illustrates an example of a system for wireless communications that supports vehicle-to-everything (V2X) traffic load control in accordance with aspects of the present disclosure.

FIG. 2 illustrates an example of a wireless communication system that supports V2X traffic load control in accordance with aspects of the present disclosure.

FIG. 3 illustrates an example of a cellular V2X (CV2X) protocol stack that supports V2X traffic load control in accordance with aspects of the present disclosure.

FIG. 4 illustrates an example of a process that supports V2X traffic load control in accordance with aspects of the present disclosure.

FIG. 5 illustrates an example of a process that supports V2X traffic load control in accordance with aspects of the present disclosure.

FIGS. 6 and 7 show block diagrams of devices that support V2X traffic load control in accordance with aspects of the present disclosure.

FIG. 8 shows a block diagram of a communication manager that supports V2X traffic load control in accordance with aspects of the present disclosure.

FIG. 9 shows a diagram of a system including a device that supports V2X traffic load control in accordance with aspects of the present disclosure.

FIGS. 10 through 14 show flowcharts illustrating methods that support V2X traffic load control in accordance with aspects of the present disclosure.

### DETAILED DESCRIPTION

A wireless multiple-access communications system may include a number of base stations or network access nodes, each simultaneously supporting communication for multiple communication devices, which may be otherwise known as user equipment (UE). Some wireless networks may support vehicle-based communications, such as vehicle-to-everything (V2X) networks, vehicle-to-vehicle (V2V) networks, cellular V2X (CV2X) networks, or other similar networks. Vehicle-based communication networks may provide always-on telematics where UEs, e.g., vehicle UEs (v-UEs), communicate directly to the network (V2N), to pedestrian UEs (V2P), to infrastructure devices (V2I), and to other v-UEs (e.g., via the network and/or directly). Communications within a vehicle-based network may be performed using signals communicated over sidelink channels, such as a physical sidelink control channel (PSCCH) or a physical sidelink shared channel (PSSCH), or both. In some aspects, communications within a CV2X network may be performed between UEs over a PC5 interface, which may include such sidelink channels.

Aspects of the disclosure are initially described in the context of a wireless communication system, such as a vehicle-based wireless or CV2X network. Aspects of the disclosure provide for improved techniques for controlling the message generation rate based on the congestion situation of the access layer in terms of the channel busy ratio, which may also include or otherwise consider the occurrence of critical events over the CV2X network. For example, an upper layer (e.g., a second protocol layer) of a UE may receive a channel occupancy ratio indication from an access layer (e.g., a first protocol layer) of the UE. In some aspects, the channel occupancy ratio indication may be on a per proximity service (ProSe) priority level basis, e.g., a ProSe per-packet priority (PPPP) level. The upper layer may identify the resources available (e.g., a resource availability metric) as well as the message requirements (e.g., a message requirement metric) for each proximity service priority level. In some aspects, the upper layer may identify or otherwise determine the message generation rate for each of the proximity service priority levels using the channel occupancy ratio, the resource availability metric, and/or the message requirement metric. Accordingly, the upper layer may generate one or more messages for each proximity service priority level according to the message generation rate.

In some aspects, the described techniques may include the access layer of the UE modifying one or more functions or parameters within its message generation based on the node(s) proximate to the UE. For example, the UE may identify the transmission periodicity for messages of a proximity service priority level. The UE may then identify a density metric (e.g., an indication of how many node(s) are within a defined proximity range of the UE), a traffic pattern (e.g., the amount and/or type of traffic being communicated by the node(s) of the CV2X network), and, for each node, the node type (e.g., whether the node is a neighboring UE, a roadside unit (RSU), a vulnerable road user (VRU), or the like). In some aspects, the UE may modify the transmission periodicity for the one or more messages using the node density metric, the node traffic pattern, and/or the node type for each node. Accordingly, the UE may modify the transmission periodicity of one or more messages in view of the current traffic pattern/node density/type within the CV2X network.

Aspects of the disclosure are further illustrated by and described with reference to apparatus diagrams, system diagrams, and flowcharts that relate to V2X traffic load control.

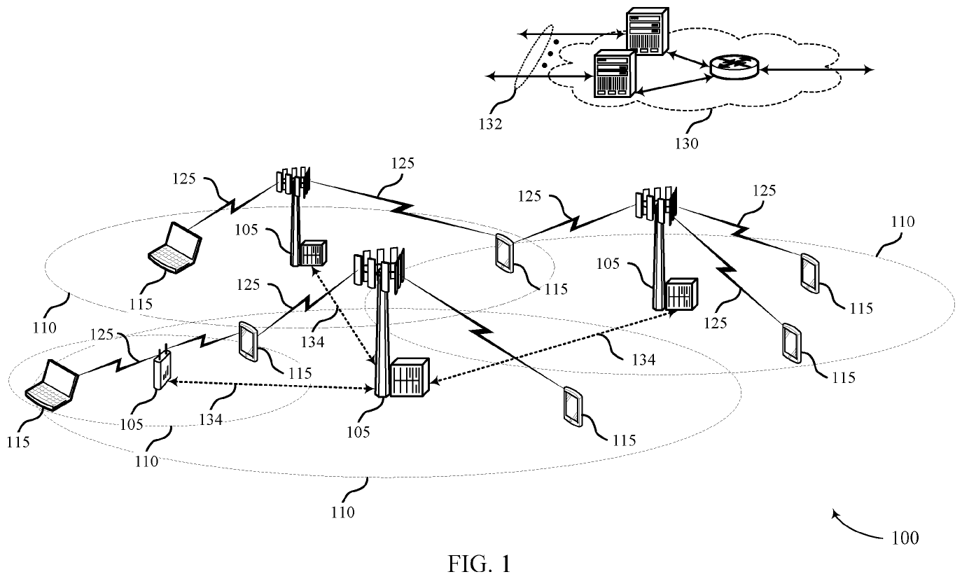

FIG. 1 illustrates an example of a wireless communications system 100 that supports V2X traffic load control in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples, a receiving device may use a single receive beam to receive along a single beam direction (e.g., when receiving a data signal). The single receive beam may be aligned in a beam direction determined based on listening according to different receive beam directions (e.g., a beam direction determined to have a highest signal strength, highest signal-to-noise ratio, or otherwise acceptable signal quality based on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

In some aspects, a UE 115 may receive, from a first protocol layer of the UE 115, a channel occupancy ratio for each of one or more proximity service priority levels. The UE 115 may identify, by a second protocol layer of the UE 115, a resource availability metric and a message requirement metric for each of the one or more proximity service priority levels, the second protocol layer being a higher layer than the first protocol layer. The UE 115 may determine, by the second protocol layer of the UE 115, a message generation rate for each of the one or more proximity service priority levels based on the channel occupancy ratio, or the resource availability metric, or the message requirement metric, or a combination thereof. The UE 115 may generate one or more messages for each of the one or more proximity service priority levels based on the message generation rate.

In some aspects, the UE 115 may identify a transmission periodicity of one or more messages of a proximity service priority level. The UE 115 may identify, for a plurality of nodes, a node density metric and a node traffic pattern. The UE 115 may identify, for each node of the plurality of nodes, a node type. The UE 115 may modify the transmission periodicity for the one or more messages based on the node density metric, or the node traffic pattern, or the node type for each node of the plurality of nodes, or a combination thereof.

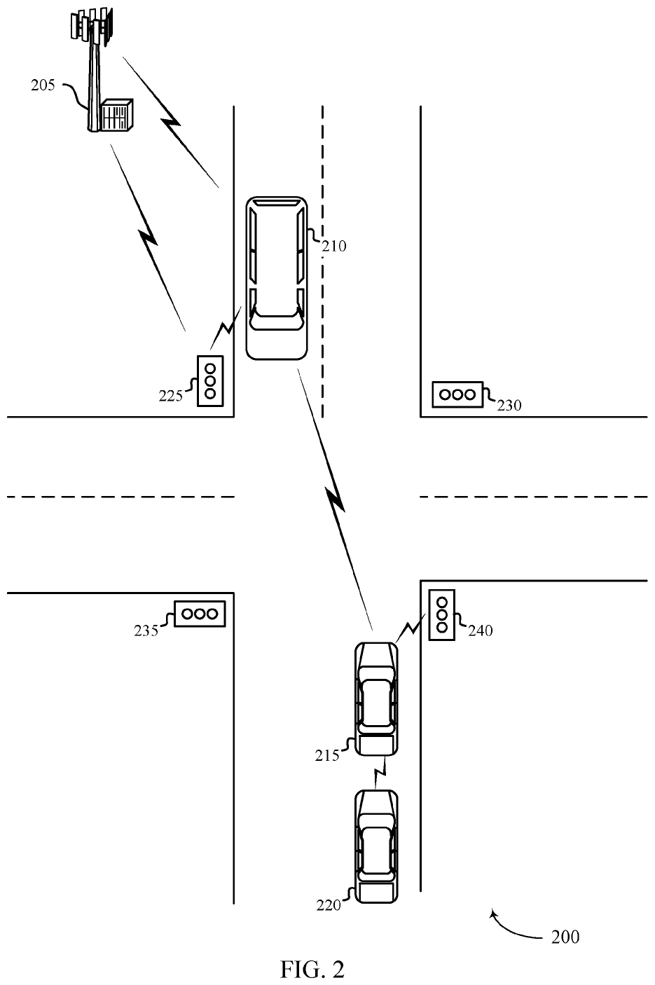

FIG. 2 illustrates an example of a wireless communication system 200 that supports V2X traffic load control in accordance with aspects of the present disclosure. In some examples, wireless communication system 200 may implement aspects of wireless communication system 100. Aspects of wireless communication system 200 may be implemented by one or more of a base station 205, a vehicle 210, a vehicle 215, a vehicle 220, a traffic light 225, a traffic light 230, a traffic light 235, and a traffic light 240. In some aspects, one or more of the traffic lights 225-240 may be examples of RSUs communicating in wireless communication system 200, although it is to be understood that other types of devices may be considered RSUs, VRUs, etc., within a CV2X network.

In some aspects, wireless communication system 200 may support vehicle safety and operational management, such as a CV2X network. Accordingly, one or more of the vehicles 210-220 and traffic lights 225-240 may be considered as UEs within the context of the CV2X network. For example, one or more of the vehicles 210-220 and traffic lights 225-240 may be equipped or otherwise configured to operate as a UE performing wireless communications over the CV2X network. In some aspects, the CV2X communications may be performed directly between base station 205 and one or more of the vehicles 210-220 and traffic lights 225-240, or indirectly via one or more hops. For example, vehicle 215 may communicate with base station 205 via one hop through vehicle 210, traffic light 240, or any other number/configuration of hop(s). In some aspects, the CV2X communications may include communicating control signals (e.g., one or more PSCCH signals) and/or data signals (e.g., one or more PSSCH signals). In some aspects, such sidelink communications may be performed over a PC5 interface between the nodes within wireless communication system 200.

In some aspects, the CV2X network may include different types of nodes communicating over the network. For example, in some aspects the vehicles 210-220 may be considered UEs within the CV2X network and traffic lights 225-240 may be considered RSUs. Generally, some nodes (e.g., RSUs) may be configured differently from other types of nodes (e.g., UEs) within the CV2X network. For example, some RSUs may have more available transmission power, e.g., due to being connected to a steady power supply instead of a battery.

In some aspects, communications within the CV2X network are performed over a PC5 direct communication interface, e.g., a distributed communication system. To ensure the system is not overloaded, the congestion control may be used to control the generation of traffic (e.g., traffic load control) as well as the use/occupation of the resources (e.g., time, frequency, spatial, code, etc., resources). Some solutions may not consider input from the access layer in determining the message generation rate. Further some solutions may consider the contribution from other vehicles (e.g., from other UEs), but not other transmission node types (e.g., RSUs, VRUs, etc.) that share the same resource pool with the vehicles (e.g., other vehicle-based UEs). Accordingly, aspects of the described techniques may consider input from both the access layer as well as the contributions from the other transmission nodes in managing message generation rate/traffic load.

In some aspects, the described techniques may control the message generation rate based on the congestion situation of the access layer in terms of the channel busy ratio (CBR), and also considers other critical events (e.g., other higher priority or one-off traffic that needs to be quickly communicated over the CV2X network). Aspects of the described techniques may use the channel occupancy ratio (CR) limit to reflect the CBR levels. In some aspects, the CR limit may refer to the available channel portion that can be used for message transmissions. If the CR limit is high or if there is no CR limit, then more messages can be generated or otherwise serviced by the access layer. Thus, the higher layer can generate messages with a higher frequency or “as required.” Otherwise, the higher layer may control or limit the message generation rate.

As discussed, aspects of the described techniques may include receiving input from the access layer (e.g., a first protocol layer of the UE) by the upper layer (e.g., a second protocol layer of the UE). Generally, the input may include the upper layer receiving a channel occupancy ratio (e.g., the CR limit) for each of one or more proximity service priority levels, e.g., per-PPPP level. In some aspects, the indication of the channel occupancy ratio received from the access layer (e.g., the first protocol layer of the UE) may be based on Table 1 below:

TABLE 1

| | PPPP1- | PPPP3- | PPPP6- |
|---|---|---|---|
| | PPPP2 | PPPP5 | PPPP8 |
| CBR Measured | CR Limit | CR Limit | CR Limit |
| 0 ≤ CBR Measured ≤ threshold1 | No | No | No |
| | Limit | Limit | Limit |
| threshold1 ≤ CBR Measured ≤ | No | 0.03 | 0.02 |
| threshold2 | Limit | | |
| threshold2 ≤ CBR Measured ≤ | 0.02 | 0.006 | 0.004 |
| threshold3 | | | |
| threshold2 ≤ CBR Measured ≤ | 0.02 | 0.003 | 0.002 |
| threshold4 | | | |

Generally, Table 1 provides an example of the relationship between CBR and CR limit under different PPPP levels. In some aspects, Table 1 may be used for congestion control at the access layer to limit the available channel for a particular node per-PPPP. However, aspects of the described techniques may include the access layer providing or otherwise conveying an indication of the parameters determined in Table 1 to an upper layer of the UE to use for determining a message generation rate for each proximity service priority level (e.g., for each PPPP level).

In some aspects, this may include the access layer providing an indication of a channel occupancy ratio (e.g., the CR limit) for each proximity service priority level to an upper layer. For example, according to the measured CBR level, the CR limit may be determined on a per-PPPP level and provided from the access layer (e.g., the first protocol layer of the UE) to the upper layer (e.g., a second protocol layer of the UE). The upper layer may identify a resource availability metric and a message requirement metric for each proximity service priority level based on the indication of the channel occupancy ratio received from the access layer.

In some aspects, this may include the upper layer determining the available sub channel number (K) for a defined time period (T_contol) according to the CR limit. That is, the resource availability metric may correspond to the number of available sub channels (K) within the defined time period (T_control). Additionally, the upper layer may also identify the message requirement metric for each proximity service priority level. In some aspects, the message requirement metric may include the modulation and coding scheme (MCS) and the transmission times being used to determine how many sub channels (M) are required to transmit one message one time. If each message needs to be transmitted X times (e.g., according to a repetition factor), where X≥1, and each regular message generation cycle (T_periodic) for each proximity service priority level, the upper layer may determine the message generation rate using this information. For example, the upper layer may determine the message generation rate using the formula K≥(T_control/T_periodic)*M*X. If K is ≥(T_control/T_periodic)*M*X, then the upper layer may determine to generate the message. If not, the upper layer may draw a uniform random number between zero and one for a Bernoulli trial, using a random number (rand( ) at the end of each T_periodic. If the outcome of the Bernoulli trial is true, e.g., if (rand( )<=K/[(T_control/T_periodic)*M*X], the upper layer may determine to generate the message. Otherwise, the upper layer may determine to not generate the message. Instead, the upper layer may perform the Bernoulli trial again at the next Tperiodic to determine whether or not to generate the message.

Accordingly, the upper layer may determine that the message generation rate satisfies a threshold value (e.g., if K is ≥(T_control/T_periodic)*M*X) and therefore generate the message according to the message generation rate satisfying the threshold. If the upper layer determines that the message generation rate fails to satisfy the threshold value, the upper layer may recalculate the message generation rate based on the random number (e.g., rand( ) and, if the outcome of the Bernoulli trial is true, generate the message according to the message generation rate. However, if the outcome of the Bernoulli trial is false, the upper layer may determine not to generate the message and, instead, run another Bernoulli trial again at the next T_periodic.

In some aspects, the described techniques may manage one or more parameters for message generation in order to control the message generation rate. For example, some examples may include the upper layer modifying a transmission periodicity for message according to the resource availability metric and/or message requirement metric. For example, the upper layer may, according to the measured CBR level, receive the indication of the CR limit from the access layer on a per-PPPP basis according to Table 1 above. With the CR limit, the upper layer may determine the available sub-channel number (K) (e.g., the number of available sub channels) within the time period (T_control) as discussed above. With the selected/configured MCS and transmission times, the upper limit may decide how many sub channels (M) are required to transmit one message one time. If each message needs to be transmitted X times (where X≥one and is based on a repetition factor) and with the CR limit, the upper layer may determine how many messages (N) can be transmitted in the T_control using N=K/(M*X). Accordingly and initially (e.g., at startup, such as at each T_control), the message can be generated and a T_nextschedulemessage value may be set to T_currenttime+transmission time interval (TTI). In some aspects, the TTI may be calculated as

$$TTI = \{ \begin{matrix}{T}_{periodic} , & \frac{T \_ control}{N} \leq T \_ periodic \\ \frac{T \_ control}{N} & \frac{T \_ control}{N} > T \_ periodic\end{matrix}$$

where T_periodic is the regular message generation cycle (e.g., the transmission periodicity of the message). For example, in some techniques the transmission periodicity for a BSM is set to 100 ms. In some aspects, the T_nextschedulemessage may be the time that is scheduled to generate the next message and the T_currenttime is the current time, e.g., the local time, the coordinated universal time (UTC). At each T_currenttime==T_nextschedulemessage (e.g., when it is time to generate the next message), the upper layer may repeat this process to determine whether or not to generate the next message. Accordingly, the upper layer may modify determine the message generation rate based on the available resource metric and the message requirement metric as discussed above. Based on the message generation rate, the UE may modify or otherwise change the transmission periodicity for one or message in order to ensure that the messages can be generated using the available resources and in view of the current traffic congestion level. The UE may generate and transmit messages according to the modified transmission periodicity.

Additionally or alternatively, some techniques may not take into account or otherwise consider the access layer congestion information (e.g., the CR limit), but may, instead, perform the traffic load control independently by reusing an existing system architecture evolution (SAE) solution. Generally, the existing SAE solution may consider or otherwise contain two aspects. The first aspect may include a BSM generation and scheduling rate, a.k.a. rate control, considering three inputs. The first input may include tracking air/vehicle dynamics, e.g., estimation of the difference between the vehicle local position and its position estimated by a remote vehicle. For example, due to transmission latency and/or over-the-air performance, remote vehicles may not always have the latest host vehicle information. The larger the estimated difference is, the higher probability the transmission would be unsuccessful. The second input may include the occurrence of critical events, e.g., hard breaking by the vehicle. Once there is a critical event, the host vehicle (e.g., the UE) may immediately schedule the BSM transmission. The third input may include the period/max_ITT, which may depend on vehicle density. The more vehicles that the host vehicle estimated (e.g., the higher the node density metric), then fewer BSMs may be generated (e.g., the maximum generation rate may be 1/600 ms, as compared to the normal generation rate of 1/100 ms). Thus, fewer BSMs may be required to be transmitted. The other aspect for such techniques may include BSM transmission power control. In some aspects, this may depend on the channel busy percentage (CBP), which is similar to the CBR of the PC5 interface. The higher the CBP, generally the less power is allowed for message transmissions, e.g., using a linear scale.

However, such techniques may not consider contributions from other transmitters (e.g., other node types), such as RSU(s), VRU(s). Instead, such techniques may consider the input (e.g., node density metric and/or node traffic pattern) from other vehicle UEs. That is, the vehicle-based UE implementing such techniques may gather or otherwise consider other vehicle-based UEs in determining or otherwise scheduling message transmissions across the CV2X network. However, this may be problematic due to the fact that other node types (e.g., RSU(s), VRU(s), etc.) may have different communication capabilities, e.g., higher transmission powers, different transmission periodicities, etc.

Accordingly, aspects of the described techniques may include the UE considering the contributions from other node types (e.g., RSU(s), VRU(s), such as traffic lights 240 or any other node type other than a UE node type) when determining its message generation rate. More particularly, the described techniques may include the UE considering the other node types and, when applicable, modifying the transmission periodicity for messages in order to control or otherwise manage the message generation rate.

For example, the UE may determine the transmission periodicity for message(s) on a per-proximity service priority level basis (e.g., on a per-PPPP basis). In some aspects, the transmission periodicity (e.g., the period/max_ITT) may refer to the periodicity in which the message(s) is/are transmitted over the CV2X network. The factors that the UE considers may include, but are not limited to, the transmission power for particular node type, e.g., the transmission power of an RSU may be 3 dB higher than the transmission power of the UE, and/or the traffic pattern for the transmission nodes. The UE may estimate the contribution from the RSU/VRU or other transmission nodes that share the same resource pool in a dynamic manner for determination of the message generation period (max_ITT).

That is, the UE may determine or otherwise identify the node density metric (e.g., how many nodes are within a defined range or are otherwise proximate to the UE) for a traffic pattern (e.g., the type, frequency, amount, etc., of traffic being communicated across the CV2X network). The UE may also determine or otherwise identify each node type, e.g., whether the other nodes are a vehicle-based UE, an RSU, a VRU, etc.

In some aspects, this may include the UE calculating or otherwise determining the received traffic amount that comes from the other vehicle-based UEs (e.g., X(k), Bytes), from RSU(s) (e.g., Y1(k), Bytes), as well as from other types of transmission nodes (e.g., Yj(k)) within a range (e.g., vPERRange) and within a period (Wₖ), where K refers to the time in which each calculation is performed. The UE may smooth the calculated traffic amount of vehicle-based UEs and other node types according to:

$${X}_{s} ( k ) = γ X ( k ) + ( 1 - γ ) X ( k - 1 ) \\ {X}_{j - s} ( k ) = γ {Y}_{j} ( k ) + ( 1 - γ ) {Y}_{j} ( k - 1 )$$

where j=1 . . . J. The UE may scale the contributions from other types of transmission nodes using:

$${N}_{j \_ sOBUeq} ( k ) = \frac{{Y}_{{j}_{s}} ( k )}{{X}_{s} ( k ) / {N}_{s} ( k )}$$

to determine the effective vehicle density (Nₛ(k)) within range as:

$${N}_{{s}_{total}} ( k ) = {N}_{s} ( k ) + \sum {N}_{{j}_{sOBUeq}} ( k ) * ( {P}_{j} / {P}_{O B U} )$$

where Nₛ(k) is the vehicle density metric. Generally, OBU refers to the onboard unit, which may be the UE function of a vehicle-based UE that is performing the calculation and/or being considered as part of the calculation, e.g., the OBU may refer to a UE. In some aspects, PRSU and POBU may refer to the allowed maximum linear transmission power of the RSU(s) and OBU(s), respectively.

In some aspects, the UE may, based on the node density metric, the node traffic pattern, and/or the node type for each node, modify or otherwise change a transmission periodicity for one or more messages being communicated across the CV2X network. In some aspects, this may include the UE determining the period/max_ITT using:

$${Max}_{ITT ( k )} = \{ \begin{matrix}100 & {N}_{stotal} ( k ) \leq B \\ 100 * \frac{{N}_{stotal} ( k )}{B} & B < {N}_{stotal} ( k ) < \frac{{vMax}_{ITT}}{100} * B \\ vMax \_ ITT & \frac{{vMax}_{ITT}}{100} * B \leq {N}_{stotal} ( k )\end{matrix}$$

where Max_ITT(k) is the message generation interval in milliseconds (e.g., the message transmission periodicity). B may refer to the density coefficient and vMax_ITT may refer to the maximum threshold (upper-bound), both of which may be pre-defined parameters.

In some other aspects, this may include the UE determining the period/max_ITT based on the node density metric, the node traffic pattern, and/or the node type for each node using:

$${Max}_{ITT ( k )} = \{ \begin{matrix}100 & {N}_{stotal} ( k ) \leq B \\ round ( 100 * \frac{{N}_{stotal} ( k )}{B} ) & B < {N}_{stotal} ( k ) < \frac{{vMax}_{ITT}}{100} * B \\ vMax \_ ITT & \frac{{vMax}_{ITT}}{100} * B \leq {N}_{stotal} ( k )\end{matrix}$$

where round ( ) is the round function, Max_ITT(k) is the message generation interval in milliseconds (e.g., the message transmission periodicity). B may refer to the density coefficient and vMax_ITT may refer to the maximum threshold (upper-bound), both of which may be pre-defined parameters.

In some aspects, any of the techniques described herein may be implemented for one or more messages that are periodically transmitted across the CV2X network. However, in some situations a critical event may occur which may prompt the UE to immediately generate and transmit a message in response to the critical event. For example, the critical event may refer to any event that may prompt an immediate transmission of a safety message within the CV2X network, e.g., a hard breaking event, an indication of a pending light change at any of traffic lights 225-240, a sudden turn, etc. The critical event may be for the vehicle-based UE performing the calculation in accordance with the described techniques, for a different vehicle-based UE located within a defined proximity range of the UE, based on an RSU/VRU, and the like.

Accordingly, aspects of the described techniques may provide for a vehicle-based UE to manage the message generation rate, directly using a higher layer function and/or indirectly by controlling or otherwise modifying the message transmission periodicity, based on a more comprehensive analysis of its environment, e.g., based on the available resources, the message requirement resources, the node density, the node traffic pattern, and/or the node type. This may improve resource usage and manage traffic congestion levels within the CV2X network.

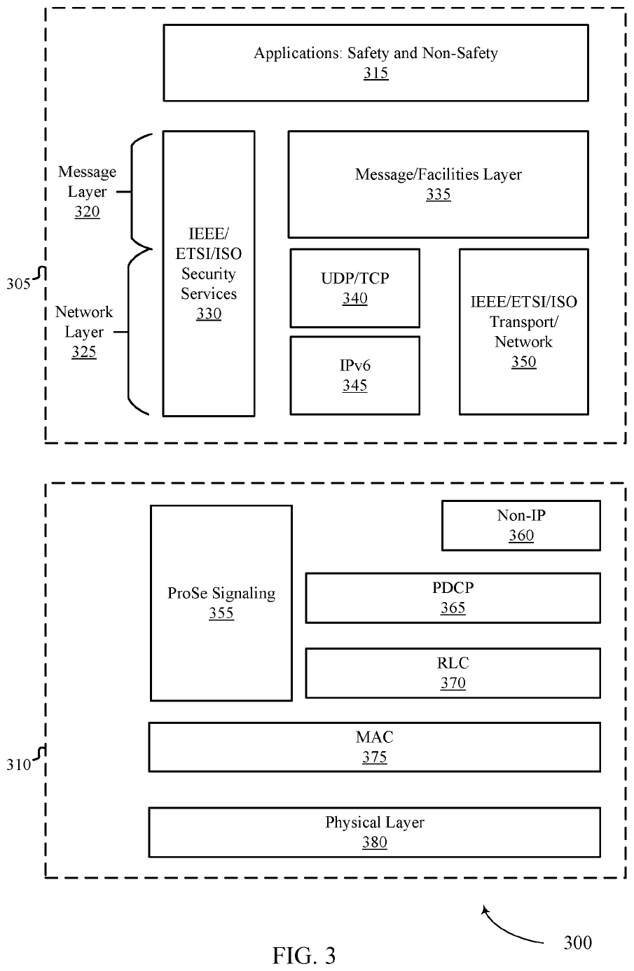

FIG. 3 illustrates an example of a CV2X protocol stack 300 that supports V2X traffic load control in accordance with aspects of the present disclosure. In some examples, CV2X protocol stack 300 may implement aspects of wireless communication systems 100 and/or 200. Aspects of CV2X protocol stack 300 may be implemented by a UE, which may be an example of corresponding device described herein.

Generally, the UE may implement CV2X protocol stack 300 when performing wireless communications within a CV2X network. CV2X protocol stack 300 may include an upper layer 305 and an access layer 310. In some examples, the upper layer 305 may be an example of a second protocol layer and the access layer 310 may be an example of a first protocol layer of the UE. In some aspects, the upper layer 305 may include an application layer 315, a message layer 320, and a network layer 325. Generally, the message layer 320 may include at least a portion of a security services layer 330 (e.g., an institute of electrical and electronics engineers (IEEE), European telecommunications standards institute (ETSI), International standards organization (ISO) security services) and a message/facilities layer 335. The network layer 325 may include a at least a portion of the security services layer 330, a user datagram protocol (UDP)/transmission control protocol (TCP) layer 340, an IPv6 layer 345, and/or a transport/network layer 350 (e.g., an IEEE/ETSI/ISO transport/network function). In some aspects, the access layer 310 may include a ProSe signaling layer 355, a non-IP layer 360, a PDCP layer 365, an RLC layer 370, a MAC layer 375, and a physical layer 380. It is to be understood that more or fewer layers may be implemented for wireless communications in CV2X protocol stack 300. Moreover, it is also to be understood that the term layers may refer to an operational layer, which may include one or more processes, functions, services, and the like, being performed by a device in hardware, software, or any combination thereof.

In some aspects, the application layer 315 may manage one or more aspects for safety and/or non-safety communication protocols and interface methods and process-2-process communications across and IP-based network. Broadly, the application layer 315 may generally be considered the top-level application suite the provides information, alerts, warnings, etc., to drivers. Within the context of a CV2X network, this may include one or more safety messages (e.g., BSM), traffic information messages (TIM)(s), and the like. In some aspects, the application layer 315 may be considered an abstraction layer that specifies the shared communications protocols and interface methods used within the communication network. Within an open systems interconnection (OSI) model, the application layer 315 may correspond to layer 7 of the protocol stack.

In some aspects, the security services layer 330 may manage one or more aspects of security for vehicle-based traffic being communicated across the CV2X network. Security within a CV2X network may be particularly important given the ad hoc nature of a vehicle-based network and in view of the serious consequences of a failure to communicate important messages, e.g., the potential for vehicle accidents caused by a loss in communicating BSM, TIM, etc. In some aspects, the security services layer 330 may monitor, control, or otherwise manage one or more aspects of threat vulnerability and risk analysis, mapping between confidentiality services, trust and privacy management, etc., for the messages being communicated across a CV2X network. In some aspects, the security services layer 330 may manage one or more aspects of security services across other layers of the upper layer 305, e.g., in combination with the messages/facilities layer 335, the UDP/TCP layer 340, etc.

In some aspects, the message/facilities layer 335 may monitor, control, or otherwise manage one or more aspects of providing facility information to applications, e.g., vehicle position, vehicle state, message set dictionaries, vehicle-to-vehicle, message transmission and reception, threat detection, and the like. For example, the message/facilities layer 335 may receive inputs from various sensors located in different locations around the vehicle, global positioning system (GPS) input, and the like, which may be used in performing wireless communications within the CV2X network and/or for vehicle operation and safety management functions. As one example, the message/facilities layer 335 may provide input that can be used to determine a node density metric, a traffic pattern, a node type, and other information, for the nodes operating within the CV2X network.

In some aspects, the UDP/TCP layer 340 may generally monitor, control, or otherwise manage one or more aspects of IP-based communications on the transport layer for CV2X protocol stack 300. Broadly, the transport layer provides services such as connection-oriented communications, reliability, flow control, multiplexing, etc. Similarly, the IPv6 layer 345 may monitor, control, or otherwise manage one or more aspects of IPv6-based communications across a CV2X network. In some aspects, the transport/network layer 350 may monitor, control, or otherwise manage one or aspects of packet forwarding, routing, etc., through and/or for one or more intermediate nodes within the CV2X network.

In some aspects, the ProSe signaling layer 355 may monitor, control, or otherwise manage one or aspects of a transmission/reception of V2X communications over a PC5 interface. For example, the proximity service signaling layer 355 may manage aspects of PC5 parameter provisioning, quality of service (QOS) management, synchronization, etc., over the PC5 interface and on a PPPP basis.

In some aspects, the non-IP layer 360 may monitor, control, or otherwise manage information being communicated using non-IP-based protocols. For example, some types of safety messages in the vehicle-based network may be inapplicable or otherwise unsuited for some IP-based communication protocols due to the large overhead associated with IP-based communications. Instead, the non-IP layer 360 may manage one or more aspects of communicating vehicle-based information over a CV2X network using a cooperative awareness message (CAM), a decentralized environmental notification message (DENM), and the like, V2V message format.

In some aspects, the PDCP layer 365 may provide multiplexing between different radio bearers and logical channels. The PDCP layer 365 also provides header compression for upper layer data packets to reduce radio transmission overhead, security by ciphering the data packets, and handover support for UEs between network devices or base stations. The RLC layer 370 provides segmentation and reassembly of upper layer data packets, retransmission of lost data packets, and reordering of data packets to compensate for out-of-order reception due to HARQ. The RLC layer 370 passes data to the MAC layer 375 as logical channels during transmit operations and/or manages aspects of maintaining the radio link for the UE.

A logical channel defines what type of information is being transmitted over the air interface (e.g., user traffic, control channels, broadcast information, etc.). In some aspects, two or more logical channels may be combined into a logical channel group (LCG). By comparison, the transport channel defines how information is being transmitted over the air interface (e.g., encoding, interleaving, etc.) and the physical channel defines where information is being transmitted over the air interface (e.g., which symbols of the slot, subframe, fame, etc., are carrying the information).

The MAC layer 375 may manage aspects of the mapping between a logical channel and a transport channel, multiplexing of MAC service data units (SDUs) from logical channel(s) onto the transport block (TB) to be delivered to L1 on transport channels, HARQ based error correction, and the like. The MAC layer 375 may also responsible for allocating the various radio resources (e.g., resource blocks) in one cell among the UEs (at the network side). The MAC layer 375 may also support aspects of HARQ operations. The MAC layer 375 formats and sends the logical channel data to the physical layer 380 as transport channels in one or more TBs. Generally, a physical layer 380 monitors, controls, or otherwise manages one or more aspects of transporting information over a wireless medium, e.g., may be responsible for encoding/decoding, modulation/demodulation, etc., for the packets being communicated within a CV2X network.

Although shown as separate functions, it is to be understood that one or more of the functions performed within the security services layer 330, message/facilities layer 335, UDP/TCP layer 340, IPv6 layer 345, and/or the transport/network layer 350 may be performed in a combined operational or functional layer or sub layer of the upper layer 305. Similarly, one or more of the functions performed within the proximity service signaling layer 355, the non-IP layer 360, the PDCP layer 365, the RLC layer 370, the MAC layer 375, and/or the physical layer 380 may be performed in a combined operational or functional layer or sub layer of the access layer 310. For example, at least some of the functions described as being performed by a single layer above may be performed in combination with, or based on information from, other layers of the upper layer 305 and/or access layer 310.

In some aspects, the upper layer 305 may manage or otherwise control one or more aspects of traffic/messages being generated in accordance with aspects of the described techniques. For example, some aspects may include the upper layer 305 relying on information provided by the access layer 310 in terms of the available resources/number of channels (e.g., the CBR, CR limit, etc.) and determining the message generation rate for such traffic. In other aspects, the access layer 310 may manage one or more aspects of the message generation rate by managing or otherwise modifying a transmission periodicity of messages over the CV2X network.

For example, one or more functions, layers, sub layers, etc., of the access layer 310 may transmit or otherwise provide a channel occupancy ratio for each of one or more proximity service priority levels to the upper layer 305. The upper layer 305 (e.g., one or more of the layers implemented in the upper layer 305) may then identify a resource availability metric and a message requirement metric for each of the one or more proximity service priority levels. The upper layer 305 may determine a message generation rate for each of the one or more proximity service party levels based on the channel occupancy ratio, the resource availability metric, and/or the message requirement metric. The upper layer 305 may generate one or more messages for each of the one or more proximity service priority levels according to the message generation rate.

As another example, one or more functions, processes, layers, etc., of the access layer 310 may identify a transmission periodicity of one or more messages of a proximity service priority level. The access layer 310 may identify a node density metric and/or a node traffic pattern for a plurality of nodes that are located within a range of the UE implementing the access layer 310. The access layer 310 may also identify, for each node, the node type, e.g., whether the node is a neighboring UE, an RSU, a VRU, etc. The access layer 310 may use this information to modify the transmission periodicity for the one or more message, e.g., in order to control the message generation rate to manage the traffic load/congestion level over the CV2X network.

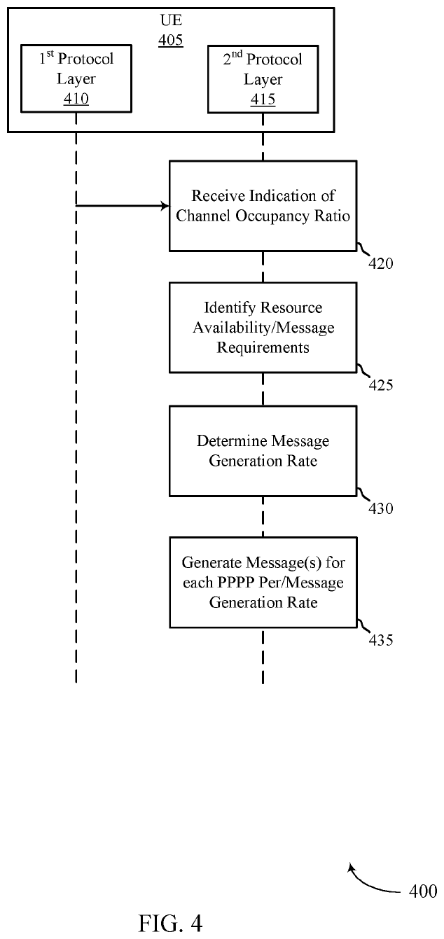

FIG. 4 illustrates an example of a process 400 that supports V2X traffic load control in accordance with aspects of the present disclosure. In some examples, process 400 may implement aspects of wireless communication systems 100 and/or 200, and/or CV2X protocol stack 300. Aspects of process 400 may be implemented by UE 405, which may be an example of the corresponding devices described herein. More particularly, aspects of process 400 may be implemented by a first protocol layer 410 and/or a second protocol layer 415 of UE 405. In some aspects, the first protocol layer 410 may be an example of an access layer and the second protocol layer may be an example of an upper layer of a CV2X protocol stack. In some aspects, the second protocol layer 415 may be a higher layer than the first protocol layer 410.

At 420, the first protocol layer 410 may transmit or otherwise provide (and the second protocol layer 415 may receive or otherwise obtain) a channel occupancy ratio for each of one or more proximity service priority levels, e.g., PPPP levels. For example, the first protocol layer 410 may transmit or otherwise provide an indication of the CBR, the CR limit, etc., to the second protocol layer 415.

At 425, the second protocol layer 415 may identify a resource availability metric and a message requirement metric for each of the one or more proximity service priority levels. In some aspects, this may include the second protocol layer 415 determining or otherwise identifying, based on the message requirement metric, a transmission periodicity of the one or more messages. In some examples, the second protocol layer 415 may modify or otherwise change the transmission periodicity based on the message generation rate. For example, the second protocol stack 415 may, alone or in combination with other layers, functions, components, etc., of UE 405, transmit the one or more messages according to the modified transmission periodicity.

In some aspects, the resource availability metric may be based, at least in some aspects, on the number of subcarriers available (K) for communicating messages within a control time period (T_control). In some aspects, the message requirement metric may be based, at least in some aspects, on the number of subcarriers (M) required for transmitting a message, the MCS for the message, a repetition factor (X) for the message, the transmission periodicity (T_period), and the like.

At 430, the second protocol layer 415 may determine a message generation rate for each of the one or more proximity service priority levels based on the channel occupancy ratio, the resource availability metric, and/or the message requirement metric. Generally, the message generation rate may correspond to the amount of messages that can be transmitted per-PPPP over the CV2X in a manner that avoids excessive traffic load/congestion over the CV2X network.

At 435, the second protocol layer 415 may generate one or more messages for each of the one or more proximity service priority levels based on the message generation rate. In some aspects, this may include the second protocol layer 415 determining that the message generation rate satisfies a threshold value, and accordingly the second protocol layer 415 may generate the one or more messages based on the message generation rate satisfying the threshold value.

In some aspects, this may include the second protocol layer 415 determining that the message generation rate fails to satisfy the threshold value. In this aspect, the second protocol layer 415 may recalculate the message generation rate using a random number and generate the one or more messages according to the recalculated message generation rate. That is, the second protocol layer 415 may generate the one or more messages if the recalculated message generation rate satisfies the threshold value. If the recalculated message generation rate fails to satisfy the threshold value, the second protocol layer 415 may refrain from, or otherwise not generate the message.

In some aspects, this may include the second protocol layer 415 determining that a critical event trigger has occurred, with the second protocol layer 415 generating and transmitting the one or more messages in response to the occurrence of the critical event trigger. Examples of the critical event trigger may include, but are not limited to, an event occurring with respect to the vehicle in which the UE 405 is operating, e.g., hard breaking, sudden turn, etc. Other examples of the critical event may include, but are not limited to, determining that a high priority message is to be communicated over the CV2X network, e.g., a message with a stringent latency requirement.

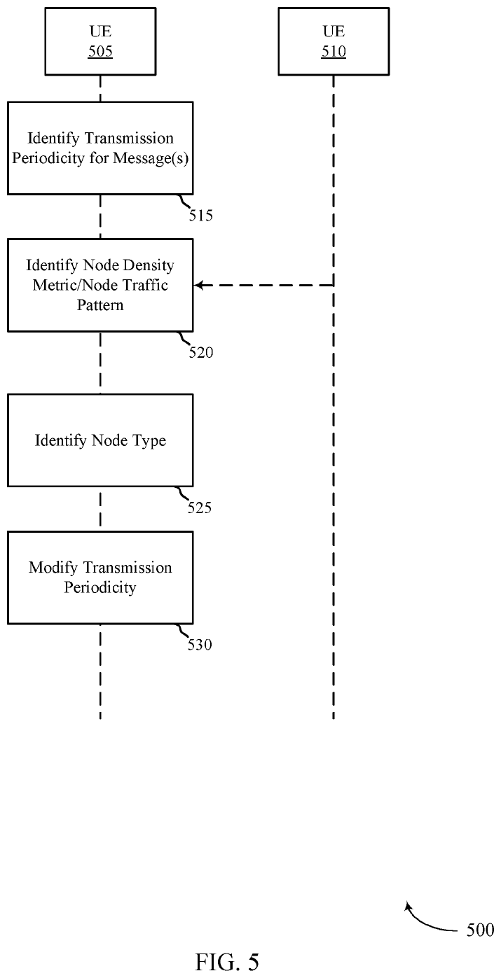

FIG. 5 illustrates an example of a process 500 that supports V2X traffic load control in accordance with aspects of the present disclosure. In some examples, process 500 may implement aspects of wireless communication systems 100 and/or 200, CV2X protocol stack 300, and/or process 400. Aspects of process 500 may be implemented by UE 505 and/or UE 510, which may be examples of the corresponding devices described herein. Although aspects of process 500 are generally described as being performed by UE 505, it is to be understood that process 500 may be implemented by any UE (or node) operating within a CV2X network according to the techniques described herein.

At 515, UE 505 may identify a transmission periodicity of one or more messages of a proximity service priority level. For example, the UE 505 may determine the periodicity in which one or more messages are to be transmitted across a CV2X network, e.g., T_period.

At 520, UE 505 may identify, for a plurality of nodes, a density metric and a node traffic pattern. In some aspects, the node density metric may be based, at least in some aspects, on the number of nodes (e.g., including UE 510) within a proximity range of UE 505. In some examples, this may include UE 505 monitoring various signals from the nodes within the proximity range, such as optionally monitoring or otherwise receiving a signal from UE 510. In some aspects, this may include UE 505 receiving a signal from a base station identifying the nodes within the proximity range of UE 505.

At 525, UE 505 may identify, for each node of the plurality of nodes, a node type. In some aspects, this may include UE 505 determining whether the node type is a neighboring UE (e.g., UE 510), an RSU, a VRU, and the like. As discussed, different types of nodes may have different transmissions capabilities such that identifying the node type may provide an indication of the transmission power or other transmission capabilities of the node. Accordingly, in some aspects this may include UE 505 determining, based on the node type, and available transmission power for each node. In some aspects, UE 505 may modify the transmission periodicity based, at least in some aspects, on the transmission power for the respective node.

At 530, UE 505 may modify the transmission periodicity for the one or more messages based, at least in some aspects, on the node density metric, the node traffic pattern, and/or the node type. For example, UE 505 may extend or contract the transmission periodicity based on its environment, as indicated by the node type, node density metric, and/or a traffic pattern.

In some aspects, this may include UE 505 determining that a critical trigger event has occurred and, in response, generating and transmitting the one or more messages in response to the occurrence of the critical event trigger. For example, the one or more messages generated and transmitted in response to the critical event trigger may be done within the defined time frame (e.g., low latency) in order to ensure that the critical event messages are received in a timely fashion by other nodes communicating in the CV2X network.

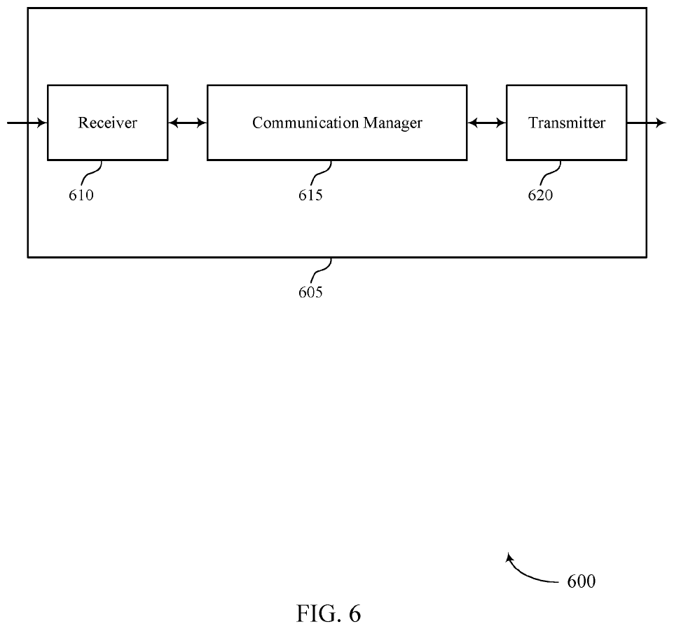

FIG. 6 shows a block diagram 600 of a device 605 that supports V2X traffic load control in accordance with aspects of the present disclosure. The device 605 may be an example of aspects of a UE 115 as described herein. The device 605 may include a receiver 610, a communication manager 615, and a transmitter 620. The device 605 may also include a processor. Each of these components may be in communication with one another (e.g., via one or more buses).

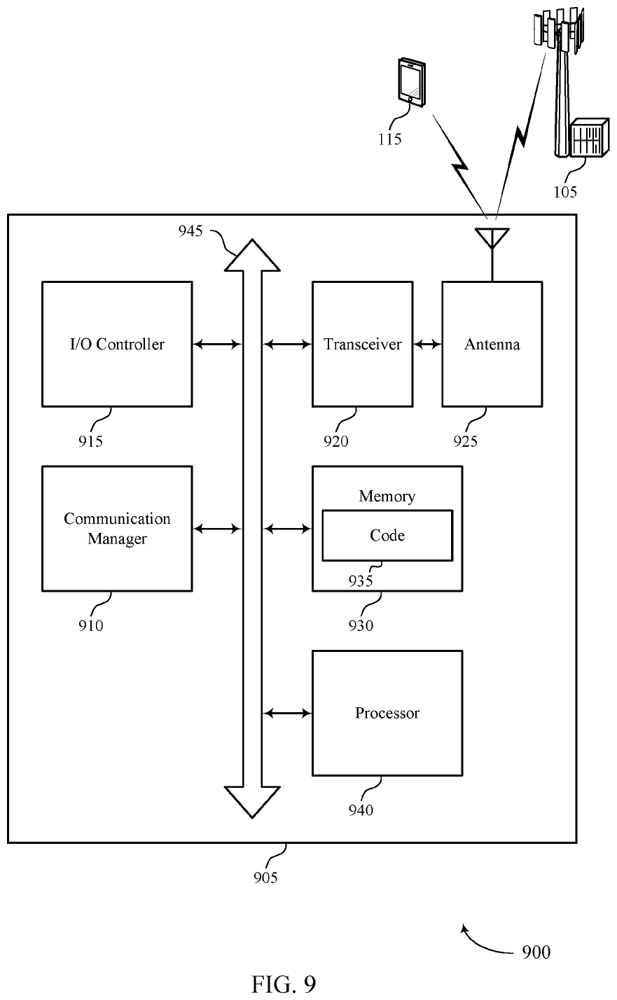

The receiver 610 may receive information such as packets, user data, or control information associated with various information channels (e.g., control channels, data channels, and information related to V2X traffic load control, etc.). Information may be passed on to other components of the device 605. The receiver 610 may be an example of aspects of the transceiver 920 described with reference to FIG. 9. The receiver 610 may utilize a single antenna or a set of antennas.

The communication manager 615 may receive, from a first protocol layer of the UE, a channel occupancy ratio for each of one or more proximity service priority levels, identify, by a second protocol layer of the UE, a resource availability metric and a message requirement metric for each of the one or more proximity service priority levels, the second protocol layer being a higher layer than the first protocol layer, determine, by the second protocol layer of the UE, a message generation rate for each of the one or more proximity service priority levels based on the channel occupancy ratio, or the resource availability metric, or the message requirement metric, or a combination thereof, and generate one or more messages for each of the one or more proximity service priority levels based on the message generation rate.

The communication manager 615 may also identify a transmission periodicity of one or more messages of a proximity service priority level, modify the transmission periodicity for the one or more messages based on the node density metric, or the node traffic pattern, or the node type for each node of the set of nodes, or a combination thereof, identify, for a set of nodes, a node density metric and a node traffic pattern, and identify, for each node of the set of nodes, a node type. The communication manager 615 may be an example of aspects of the communication manager 910 described herein. The actions performed by the communication manager 615 as described herein may be implemented to realize one or more potential advantages. One implementation may allow a UE to save power and increase battery life by generating an appropriate number of messages based on a congestion level in the network. Additionally or alternatively, the UE may avoid generating excess messages thereby conserving processing resources. Another implementation may provide improved safety at the UE, as real-time signaling may be improved.

The communication manager 615, or its sub-components, may be implemented in hardware, code (e.g., software or firmware) executed by a processor, or any combination thereof. If implemented in code executed by a processor, the functions of the communication manager 615, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communication manager 615, or its sub-components, may be physically located at various positions, including being distributed such that portions of functions are implemented at different physical locations by one or more physical components. In some examples, the communication manager 615, or its sub-components, may be a separate and distinct component in accordance with various aspects of the present disclosure. In some examples, the communication manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

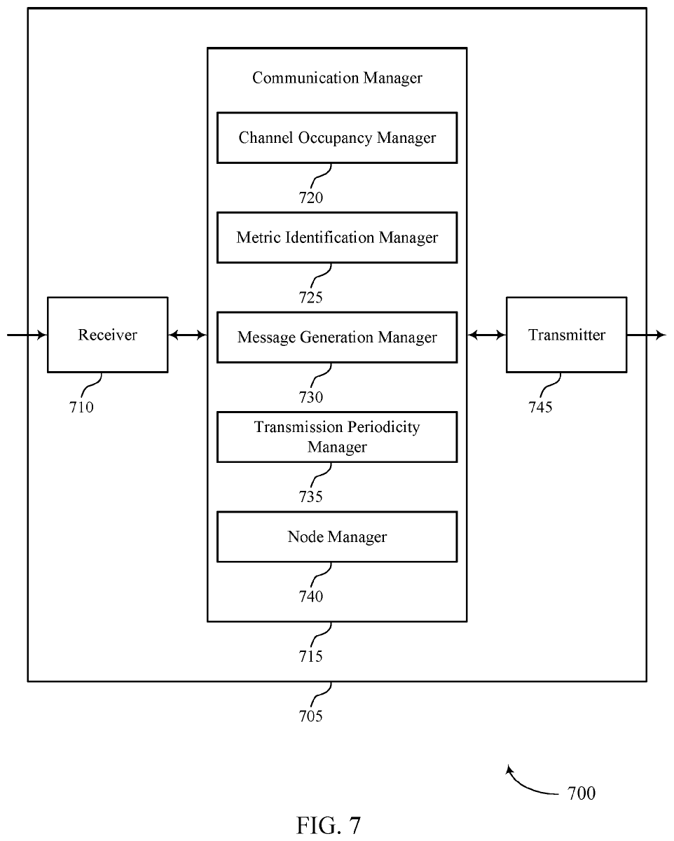

FIG. 7 shows a block diagram 700 of a device 705 that supports V2X traffic load control in accordance with aspects of the present disclosure. The device 705 may be an example of aspects of a device 605, or a UE 115 as described herein. The device 705 may include a receiver 710, a communication manager 715, and a transmitter 745. The device 705 may also include a processor. Each of these components may be in communication with one another (e.g., via one or more buses).

The receiver 710 may receive information such as packets, user data, or control information associated with various information channels (e.g., control channels, data channels, and information related to V2X traffic load control, etc.). Information may be passed on to other components of the device 705. The receiver 710 may be an example of aspects of the transceiver 920 described with reference to FIG. 9. The receiver 710 may utilize a single antenna or a set of antennas.

The communication manager 715 may be an example of aspects of the communication manager 615 as described herein. The communication manager 715 may include a channel occupancy manager 720, a metric identification manager 725, a message generation manager 730, a transmission periodicity manager 735, and a node manager 740. The communication manager 715 may be an example of aspects of the communication manager 910 described herein.

The channel occupancy manager 720 may receive, from a first protocol layer of the UE, a channel occupancy ratio for each of one or more proximity service priority levels.

The metric identification manager 725 may identify, by a second protocol layer of the UE, a resource availability metric and a message requirement metric for each of the one or more proximity service priority levels, the second protocol layer being a higher layer than the first protocol layer.

The message generation manager 730 may determine, by the second protocol layer of the UE, a message generation rate for each of the one or more proximity service priority levels based on the channel occupancy ratio, or the resource availability metric, or the message requirement metric, or a combination thereof and generate one or more messages for each of the one or more proximity service priority levels based on the message generation rate.

The transmission periodicity manager 735 may identify a transmission periodicity of one or more messages of a proximity service priority level and modify the transmission periodicity for the one or more messages based on the node density metric, or the node traffic pattern, or the node type for each node of the set of nodes, or a combination thereof

The node manager 740 may identify, for a set of nodes, a node density metric and a node traffic pattern and identify, for each node of the set of nodes, a node type. Based on determining the node density metric, or the node traffic pattern, or the node type for each node of the plurality of nodes, or a combination thereof satisfies a threshold condition, a processor of a UE (e.g., controlling the receiver 710, the transmitter 745, or the transceiver 920 as described with reference to FIG. 9) may efficiently determining the transmission periodicity is one of a maximum transmission periodicity, a round function applied to a value, or 100 milliseconds. Further, the processor of UE may determining that a critical event trigger has occurred. The processor of the UE may turn on one or more processing units for generating and transmitting one or more messages in response to the occurrence of the critical event trigger, increase a processing clock, or a similar mechanism within the UE. As such, when the one or more messages is transmitted, the processor may be ready to respond more efficiently through the reduction of a ramp up in processing power.

The transmitter 745 may transmit signals generated by other components of the device 705. In some examples, the transmitter 745 may be collocated with a receiver 710 in a transceiver module. For example, the transmitter 745 may be an example of aspects of the transceiver 920 described with reference to FIG. 9. The transmitter 745 may utilize a single antenna or a set of antennas.

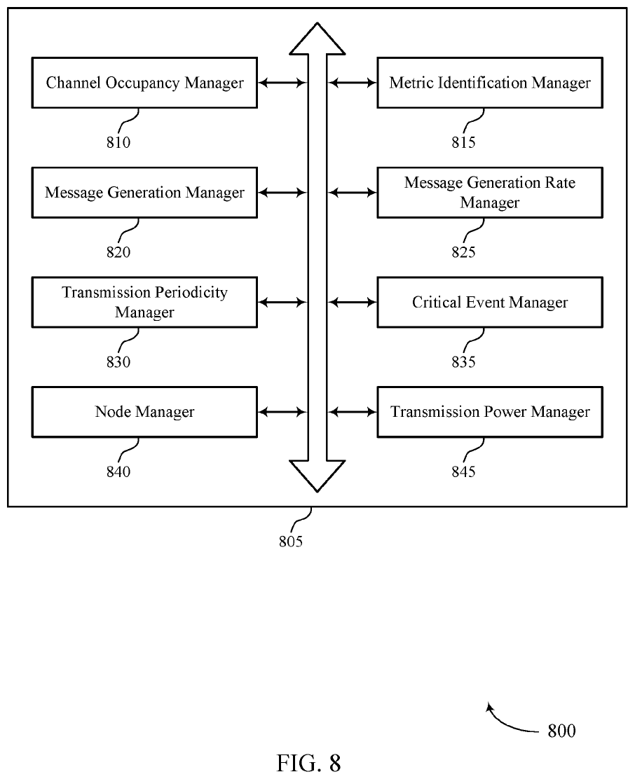

FIG. 8 shows a block diagram 800 of a communication manager 805 that supports V2X traffic load control in accordance with aspects of the present disclosure. The communication manager 805 may be an example of aspects of a communication manager 615, a communication manager 715, or a communication manager 910 described herein. The communication manager 805 may include a channel occupancy manager 810, a metric identification manager 815, a message generation manager 820, a message generation rate manager 825, a transmission periodicity manager 830, a critical event manager 835, a node manager 840, and a transmission power manager 845. Each of these modules may communicate, directly or indirectly, with one another (e.g., via one or more buses).

The channel occupancy manager 810 may receive, from a first protocol layer of the UE, a channel occupancy ratio for each of one or more proximity service priority levels.

The metric identification manager 815 may identify, by a second protocol layer of the UE, a resource availability metric and a message requirement metric for each of the one or more proximity service priority levels, the second protocol layer being a higher layer than the first protocol layer. In some examples, the metric identification manager 815 may identify a number of subcarriers available for communicating the one or more messages within a control time period. In some examples, the metric identification manager 815 may identify a number of subcarriers required for communicating the one or more messages, or a modulation and coding scheme for the one or more messages, or a repetition factor for each of the one or more messages, or a transmission periodicity of the one or more messages, or a combination thereof.

The message generation manager 820 may determine, by the second protocol layer of the UE, a message generation rate for each of the one or more proximity service priority levels based on the channel occupancy ratio, or the resource availability metric, or the message requirement metric, or a combination thereof. In some examples, the message generation manager 820 may generate one or more messages for each of the one or more proximity service priority levels based on the message generation rate.

The transmission periodicity manager 830 may identify a transmission periodicity of one or more messages of a proximity service priority level. In some examples, the transmission periodicity manager 830 may modify the transmission periodicity for the one or more messages based on the node density metric, or the node traffic pattern, or the node type for each node of the set of nodes, or a combination thereof. In some examples, the transmission periodicity manager 830 may identify, based on the message requirement metric, a transmission periodicity of the one or more messages.

In some examples, the transmission periodicity manager 830 may modify the transmission periodicity based on the message generation rate. In some examples, the transmission periodicity manager 830 may transmit the one or more messages based on the modified transmission periodicity. In some examples, the transmission periodicity manager 830 may determine the node density metric, or the node traffic pattern, or the node type for each node of the plurality of nodes, or a combination thereof satisfies a threshold condition, and may determine the transmission periodicity is one of a maximum transmission periodicity, a round function applied to a value, or 100 milliseconds based at least in part on determining that the node density metric, or the node traffic pattern, or the node type for each node of the plurality of nodes, or a combination thereof satisfies the threshold condition, wherein the value is based at least in part on the node density metric, or the node traffic pattern, or the node type for each node of the plurality of nodes, or a combination thereof.

The node manager 840 may identify, for a set of nodes, a node density metric and a node traffic pattern. In some examples, the node manager 840 may identify, for each node of the set of nodes, a node type. In some cases, the node density metric is based on a number of nodes within a proximity range of the UE. In some cases, the node type includes at least one of a neighboring UE, or a roadside unit, or a vulnerable road user, or a combination thereof.

The message generation rate manager 825 may determine that the message generation rate satisfies a threshold value, where the one or more messages are generated based on the message generation rate satisfying the threshold value. In some examples, the message generation rate manager 825 may determine that the message generation rate fails to satisfy a threshold value. In some examples, the message generation rate manager 825 may recalculate the message generation rate based on a random number, where the one or more messages are generated based on the recalculated message generation rate.

The critical event manager 835 may determine that a critical event trigger has occurred. In some examples, the critical event manager 835 may generate and transmitting the one or more messages in response to the occurrence of the critical event trigger. In some examples, the critical event manager 835 may determine that a critical event trigger has occurred. In some examples, the critical event manager 835 may generate and transmitting the one or more messages in response to the occurrence of the critical event trigger.

The transmission power manager 845 may determine, based on the node type, an available transmission power for each node of the set of nodes, where the modified transmission periodicity is based on the available transmission power for each node.

FIG. 9 shows a diagram of a system 900 including a device 905 that supports V2X traffic load control in accordance with aspects of the present disclosure. The device 905 may be an example of or include the components of device 605, device 705, or a UE 115 as described herein. The device 905 may include components for bi-directional voice and data communications including components for transmitting and receiving communications, including a communication manager 910, an I/O controller 915, a transceiver 920, an antenna 925, memory 930, and a processor 940. These components may be in electronic communication via one or more buses (e.g., bus 945).

The communication manager 910 may receive, from a first protocol layer of the UE, a channel occupancy ratio for each of one or more proximity service priority levels, identify, by a second protocol layer of the UE, a resource availability metric and a message requirement metric for each of the one or more proximity service priority levels, the second protocol layer being a higher layer than the first protocol layer, determine, by the second protocol layer of the UE, a message generation rate for each of the one or more proximity service priority levels based on the channel occupancy ratio, or the resource availability metric, or the message requirement metric, or a combination thereof, and generate one or more messages for each of the one or more proximity service priority levels based on the message generation rate.

The communication manager 910 may also identify a transmission periodicity of one or more messages of a proximity service priority level, modify the transmission periodicity for the one or more messages based on the node density metric, or the node traffic pattern, or the node type for each node of the set of nodes, or a combination thereof, identify, for a set of nodes, a node density metric and a node traffic pattern, and identify, for each node of the set of nodes, a node type.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described herein. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include random-access memory (RAM) and read-only memory (ROM). The memory 930 may store computer-readable, computer-executable code 935 including instructions that, when executed, cause the processor to perform various functions described herein. In some cases, the memory 930 may contain, among other things, a basic input/basic output system (BIOS) which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting V2X traffic load control).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

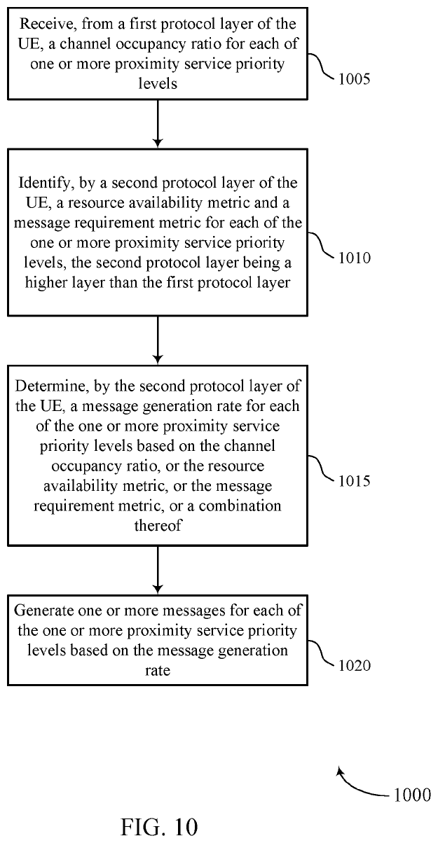

FIG. 10 shows a flowchart illustrating a method 1000 that supports V2X traffic load control in accordance with aspects of the present disclosure. The operations of method 1000 may be implemented by a UE 115 or its components as described herein. For example, the operations of method 1000 may be performed by a communication manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1005, the UE may receive, from a first protocol layer of the UE, a channel occupancy ratio for each of one or more proximity service priority levels. The operations of 1005 may be performed according to the methods described herein. In some examples, aspects of the operations of 1005 may be performed by a channel occupancy manager as described with reference to FIGS. 6 through 9.

At 1010, the UE may identify, by a second protocol layer of the UE, a resource availability metric and a message requirement metric for each of the one or more proximity service priority levels, the second protocol layer being a higher layer than the first protocol layer. The operations of 1010 may be performed according to the methods described herein. In some examples, aspects of the operations of 1010 may be performed by a metric identification manager as described with reference to FIGS. 6 through 9.

At 1015, the UE may determine, by the second protocol layer of the UE, a message generation rate for each of the one or more proximity service priority levels based on the channel occupancy ratio, or the resource availability metric, or the message requirement metric, or a combination thereof The operations of 1015 may be performed according to the methods described herein. In some examples, aspects of the operations of 1015 may be performed by a message generation manager as described with reference to FIGS. 6 through 9.

At 1020, the UE may generate one or more messages for each of the one or more proximity service priority levels based on the message generation rate. The operations of 1020 may be performed according to the methods described herein. In some examples, aspects of the operations of 1020 may be performed by a message generation manager as described with reference to FIGS. 6 through 9.

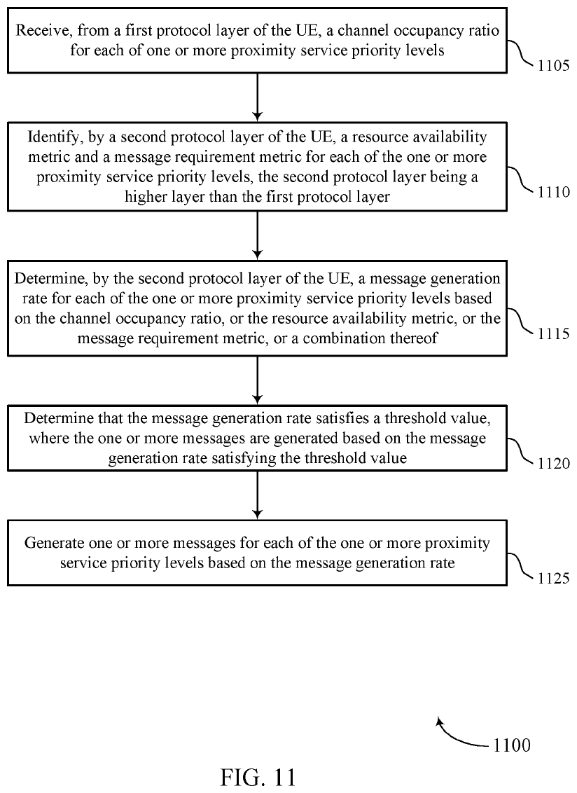

FIG. 11 shows a flowchart illustrating a method 1100 that supports V2X traffic load control in accordance with aspects of the present disclosure. The operations of method 1100 may be implemented by a UE 115 or its components as described herein. For example, the operations of method 1100 may be performed by a communication manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1105, the UE may receive, from a first protocol layer of the UE, a channel occupancy ratio for each of one or more proximity service priority levels. The operations of 1105 may be performed according to the methods described herein. In some examples, aspects of the operations of 1105 may be performed by a channel occupancy manager as described with reference to FIGS. 6 through 9.

At 1110, the UE may identify, by a second protocol layer of the UE, a resource availability metric and a message requirement metric for each of the one or more proximity service priority levels, the second protocol layer being a higher layer than the first protocol layer. The operations of 1110 may be performed according to the methods described herein. In some examples, aspects of the operations of 1110 may be performed by a metric identification manager as described with reference to FIGS. 6 through 9.

At 1115, the UE may determine, by the second protocol layer of the UE, a message generation rate for each of the one or more proximity service priority levels based on the channel occupancy ratio, or the resource availability metric, or the message requirement metric, or a combination thereof The operations of 1115 may be performed according to the methods described herein. In some examples, aspects of the operations of 1115 may be performed by a message generation manager as described with reference to FIGS. 6 through 9.

At 1120, the UE may determine that the message generation rate satisfies a threshold value, where the one or more messages are generated based on the message generation rate satisfying the threshold value. The operations of 1120 may be performed according to the methods described herein. In some examples, aspects of the operations of 1120 may be performed by a message generation rate manager as described with reference to FIGS. 6 through 9.

At 1125, the UE may generate one or more messages for each of the one or more proximity service priority levels based on the message generation rate. The operations of 1125 may be performed according to the methods described herein. In some examples, aspects of the operations of 1125 may be performed by a message generation manager as described with reference to FIGS. 6 through 9.

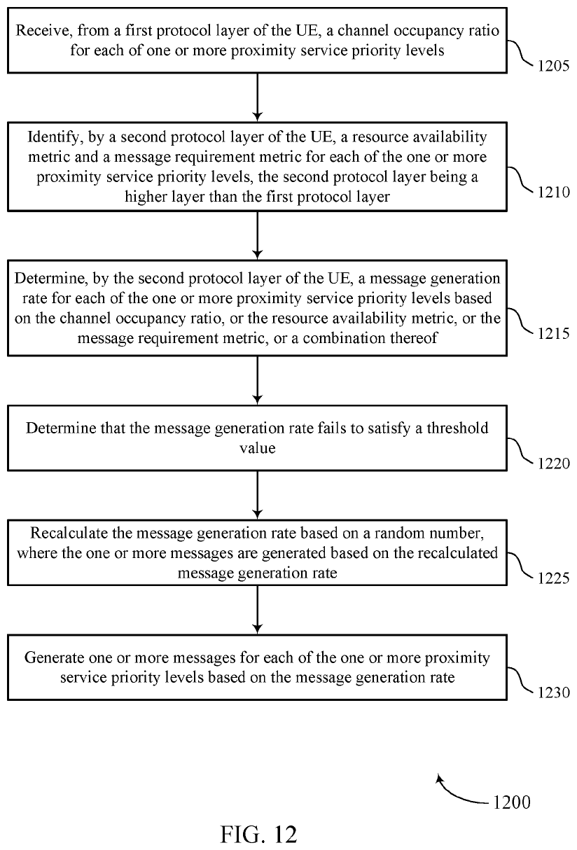

FIG. 12 shows a flowchart illustrating a method 1200 that supports V2X traffic load control in accordance with aspects of the present disclosure. The operations of method 1200 may be implemented by a UE 115 or its components as described herein. For example, the operations of method 1200 may be performed by a communication manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1205, the UE may receive, from a first protocol layer of the UE, a channel occupancy ratio for each of one or more proximity service priority levels. The operations of 1205 may be performed according to the methods described herein. In some examples, aspects of the operations of 1205 may be performed by a channel occupancy manager as described with reference to FIGS. 6 through 9.

At 1210, the UE may identify, by a second protocol layer of the UE, a resource availability metric and a message requirement metric for each of the one or more proximity service priority levels, the second protocol layer being a higher layer than the first protocol layer. The operations of 1210 may be performed according to the methods described herein. In some examples, aspects of the operations of 1210 may be performed by a metric identification manager as described with reference to FIGS. 6 through 9.

At 1215, the UE may determine, by the second protocol layer of the UE, a message generation rate for each of the one or more proximity service priority levels based on the channel occupancy ratio, or the resource availability metric, or the message requirement metric, or a combination thereof The operations of 1215 may be performed according to the methods described herein. In some examples, aspects of the operations of 1215 may be performed by a message generation manager as described with reference to FIGS. 6 through 9.

At 1220, the UE may determine that the message generation rate fails to satisfy a threshold value. The operations of 1220 may be performed according to the methods described herein. In some examples, aspects of the operations of 1220 may be performed by a message generation rate manager as described with reference to FIGS. 6 through 9.

At 1225, the UE may recalculate the message generation rate based on a random number, where the one or more messages are generated based on the recalculated message generation rate. The operations of 1225 may be performed according to the methods described herein. In some examples, aspects of the operations of 1225 may be performed by a message generation rate manager as described with reference to FIGS. 6 through 9.

At 1230, the UE may generate one or more messages for each of the one or more proximity service priority levels based on the message generation rate. The operations of 1230 may be performed according to the methods described herein. In some examples, aspects of the operations of 1230 may be performed by a message generation manager as described with reference to FIGS. 6 through 9.

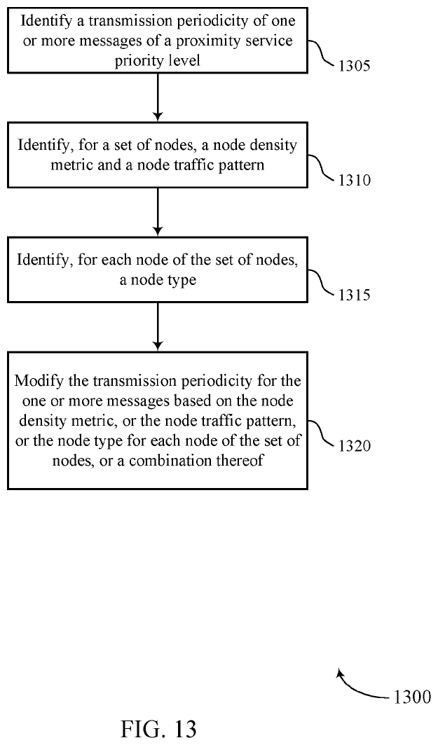

FIG. 13 shows a flowchart illustrating a method 1300 that supports V2X traffic load control in accordance with aspects of the present disclosure. The operations of method 1300 may be implemented by a UE 115 or its components as described herein. For example, the operations of method 1300 may be performed by a communication manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1305, the UE may identify a transmission periodicity of one or more messages of a proximity service priority level. The operations of 1305 may be performed according to the methods described herein. In some examples, aspects of the operations of 1305 may be performed by a transmission periodicity manager as described with reference to FIGS. 6 through 9.

At 1310, the UE may identify, for a set of nodes, a node density metric and a node traffic pattern. The operations of 1310 may be performed according to the methods described herein. In some examples, aspects of the operations of 1310 may be performed by a node manager as described with reference to FIGS. 6 through 9.

At 1315, the UE may identify, for each node of the set of nodes, a node type. The operations of 1315 may be performed according to the methods described herein. In some examples, aspects of the operations of 1315 may be performed by a node manager as described with reference to FIGS. 6 through 9.

At 1320, the UE may modify the transmission periodicity for the one or more messages based on the node density metric, or the node traffic pattern, or the node type for each node of the set of nodes, or a combination thereof. The operations of 1320 may be performed according to the methods described herein. In some examples, aspects of the operations of 1320 may be performed by a transmission periodicity manager as described with reference to FIGS. 6 through 9.

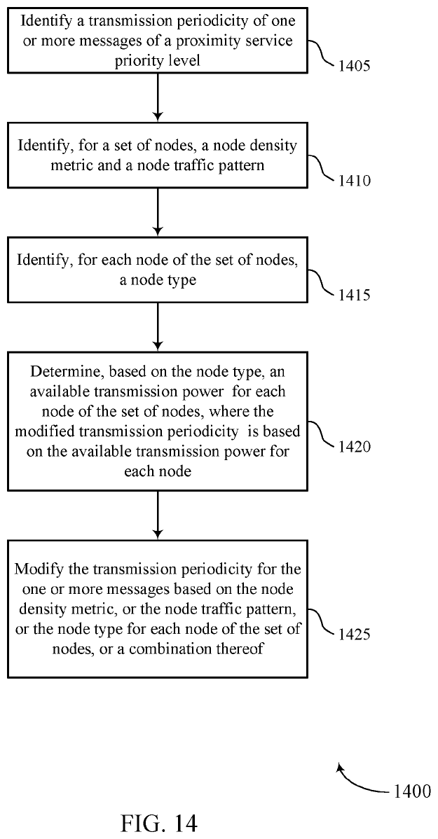

FIG. 14 shows a flowchart illustrating a method 1400 that supports V2X traffic load control in accordance with aspects of the present disclosure. The operations of method 1400 may be implemented by a UE 115 or its components as described herein. For example, the operations of method 1400 may be performed by a communication manager as described with reference to FIGS. 6 through 9. In some examples, a UE may execute a set of instructions to control the functional elements of the UE to perform the functions described herein. Additionally or alternatively, a UE may perform aspects of the functions described herein using special-purpose hardware.

At 1405, the UE may identify a transmission periodicity of one or more messages of a proximity service priority level. The operations of 1405 may be performed according to the methods described herein. In some examples, aspects of the operations of 1405 may be performed by a transmission periodicity manager as described with reference to FIGS. 6 through 9.

At 1410, the UE may identify, for a set of nodes, a node density metric and a node traffic pattern. The operations of 1410 may be performed according to the methods described herein. In some examples, aspects of the operations of 1410 may be performed by a node manager as described with reference to FIGS. 6 through 9.

At 1415, the UE may identify, for each node of the set of nodes, a node type. The operations of 1415 may be performed according to the methods described herein. In some examples, aspects of the operations of 1415 may be performed by a node manager as described with reference to FIGS. 6 through 9.

At 1420, the UE may determine, based on the node type, an available transmission power for each node of the set of nodes, where the modified transmission periodicity is based on the available transmission power for each node. The operations of 1420 may be performed according to the methods described herein. In some examples, aspects of the operations of 1420 may be performed by a transmission power manager as described with reference to FIGS. 6 through 9.

At 1425, the UE may modify the transmission periodicity for the one or more messages based on the node density metric, or the node traffic pattern, or the node type for each node of the set of nodes, or a combination thereof. The operations of 1425 may be performed according to the methods described herein. In some examples, aspects of the operations of 1425 may be performed by a transmission periodicity manager as described with reference to FIGS. 6 through 9.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
receiving, from a first protocol layer of the UE, a channel occupancy ratio for each of one or more proximity service priority levels;
identifying, by a second protocol layer of the UE, a resource availability metric and a message requirement metric for each of the one or more proximity service priority levels, the second protocol layer being a higher layer than the first protocol layer;
determining, by the second protocol layer of the UE, a message generation rate for each of the one or more proximity service priority levels based at least in part on the channel occupancy ratio, or the resource availability metric, or the message requirement metric, or a combination thereof; and
generating one or more messages for each of the one or more proximity service priority levels based at least in part on the message generation rate.

2. The method of claim 1, further comprising:
determining that the message generation rate satisfies a threshold value, wherein the one or more messages are generated based at least in part on the message generation rate satisfying the threshold value.

3. The method of claim 1, further comprising:
determining that the message generation rate fails to satisfy a threshold value; and
recalculating the message generation rate based at least in part on a random number, wherein the one or more messages are generated based at least in part on the recalculated message generation rate.

4. The method of claim 1, further comprising:
identifying, based at least in part on the message requirement metric, a transmission periodicity of the one or more messages; and
modifying the transmission periodicity based at least in part on the message generation rate.

5. The method of claim 4, further comprising;
transmitting the one or more messages based at least in part on the modified transmission periodicity.

6. The method of claim 1, further comprising:
determining that a critical event trigger has occurred; and
generating and transmitting the one or more messages in response to the occurrence of the critical event trigger.

7. The method of claim 1, wherein identifying the resource availability metric comprises:
identifying a number of subcarriers available for communicating the one or more messages within a control time period.

8. The method of claim 1, wherein identifying the message requirement metric comprises:
identifying a number of subcarriers required for communicating the one or more messages, or a modulation and coding scheme for the one or more messages, or a repetition factor for each of the one or more messages, or a transmission periodicity of the one or more messages, or a combination thereof.

9. A method for wireless communication at a user equipment (UE), comprising:
identifying a transmission periodicity of one or more messages of a proximity service priority level;
identifying, for a plurality of nodes, a node density metric and a node traffic pattern;
identifying, for each node of the plurality of nodes, a node type; and
modifying the transmission periodicity of the one or more messages based at least in part on the node density metric, or the node traffic pattern, or the node type for each node of the plurality of nodes, or a combination thereof.

10. The method of claim 9, further comprising:
determining, based at least in part on the node type, an available transmission power for each node of the plurality of nodes, wherein the modified transmission periodicity is based at least in part on the available transmission power for each node.

11. The method of claim 9, further comprising:
determining that a critical event trigger has occurred; and
generating and transmitting the one or more messages in response to the occurrence of the critical event trigger.

12. The method of claim 9, wherein the node density metric is based at least in part on a number of nodes within a proximity range of the UE.

13. The method of claim 9, wherein the node type comprises at least one of a neighboring UE, or a roadside unit, or a vulnerable road user, or a combination thereof

14. The method of claim 9, wherein modifying the transmission periodicity further comprises:
determining the node density metric, or the node traffic pattern, or the node type for each node of the plurality of nodes, or a combination thereof satisfies a threshold condition; and
determining the transmission periodicity is one of a maximum transmission periodicity, a round function applied to a value, or 100 milliseconds based at least in part on determining that the node density metric, or the node traffic pattern, or the node type for each node of the plurality of nodes, or a combination thereof satisfies the threshold condition, wherein the value is based at least in part on the node density metric, or the node traffic pattern, or the node type for each node of the plurality of nodes, or a combination thereof.

15. An apparatus for wireless communication at a user equipment (UE), comprising:
a processor,
memory coupled with the processor; and
instructions stored in the memory and executable by the processor to cause the apparatus to:
receive, from a first protocol layer of the UE, a channel occupancy ratio for each of one or more proximity service priority levels;
identify, by a second protocol layer of the UE, a resource availability metric and a message requirement metric for each of the one or more proximity service priority levels, the second protocol layer being a higher layer than the first protocol layer;
determine, by the second protocol layer of the UE, a message generation rate for each of the one or more proximity service priority levels based at least in part on the channel occupancy ratio, or the resource availability metric, or the message requirement metric, or a combination thereof; and
generate one or more messages for each of the one or more proximity service priority levels based at least in part on the message generation rate.

16. The apparatus of claim 15, wherein the instructions are further executable by the processor to cause the apparatus to:
determine that the message generation rate satisfies a threshold value, wherein the one or more messages are generated based at least in part on the message generation rate satisfying the threshold value.

17. The apparatus of claim 15, wherein the instructions are further executable by the processor to cause the apparatus to:
determine that the message generation rate fails to satisfy a threshold value; and
recalculate the message generation rate based at least in part on a random number, wherein the one or more messages are generated based at least in part on the recalculated message generation rate.

18. The apparatus of claim 15, wherein the instructions are further executable by the processor to cause the apparatus to:
identify, based at least in part on the message requirement metric, a transmission periodicity of the one or more messages; and
modify the transmission periodicity based at least in part on the message generation rate.

19. The apparatus of claim 18, wherein the instructions are further executable by the processor to cause the apparatus to:
transmit the one or more messages based at least in part on the modified transmission periodicity.

20. The apparatus of claim 15, wherein the instructions are further executable by the processor to cause the apparatus to:
determine that a critical event trigger has occurred; and
generate and transmitting the one or more messages in response to the occurrence of the critical event trigger.

21. The apparatus of claim 15, wherein the instructions to identify the resource availability metric are executable by the processor to cause the apparatus to:
identify a number of subcarriers available for communicating the one or more messages within a control time period.

22. The apparatus of claim 15, wherein the instructions to identify the message requirement metric are executable by the processor to cause the apparatus to:
identify a number of subcarriers required for communicating the one or more messages, or a modulation and coding scheme for the one or more messages, or a repetition factor for each of the one or more messages, or a transmission periodicity of the one or more messages, or a combination thereof.

23. An apparatus for wireless communication at a user equipment (UE), comprising:
a processor,
memory coupled with the processor; and
instructions stored in the memory and executable by the processor to cause the apparatus to:
identify a transmission periodicity of one or more messages of a proximity service priority level;
identify, for a plurality of nodes, a node density metric and a node traffic pattern;
identify, for each node of the plurality of nodes, a node type; and
modify the transmission periodicity for the one or more messages based at least in part on the node density metric, or the node traffic pattern, or the node type for each node of the plurality of nodes, or a combination thereof.

24. The apparatus of claim 23, wherein the instructions are further executable by the processor to cause the apparatus to:
determine, based at least in part on the node type, an available transmission power for each node of the plurality of nodes, wherein the modified transmission periodicity is based at least in part on the available transmission power for each node.

25. The apparatus of claim 23, wherein the instructions are further executable by the processor to cause the apparatus to:
determine that a critical event trigger has occurred; and
generate and transmitting the one or more messages in response to the occurrence of the critical event trigger.

26. The apparatus of claim 23, wherein the node density metric is based at least in part on a number of nodes within a proximity range of the UE.

27. The apparatus of claim 23, wherein the node type comprises at least one of a neighboring UE, or a roadside unit, or a vulnerable road user, or a combination thereof.

28. An apparatus for wireless communication at a user equipment (UE), comprising:
means for receiving, from a first protocol layer of the UE, a channel occupancy ratio for each of one or more proximity service priority levels;
means for identifying, by a second protocol layer of the UE, a resource availability metric and a message requirement metric for each of the one or more proximity service priority levels, the second protocol layer being a higher layer than the first protocol layer;
means for determining, by the second protocol layer of the UE, a message generation rate for each of the one or more proximity service priority levels based at least in part on the channel occupancy ratio, or the resource availability metric, or the message requirement metric, or a combination thereof; and
means for generating one or more messages for each of the one or more proximity service priority levels based at least in part on the message generation rate.

29. An apparatus for wireless communication at a user equipment (UE), comprising:
means for identifying a transmission periodicity of one or more messages of a proximity service priority level;
means for identifying, for a plurality of nodes, a node density metric and a node traffic pattern;
means for identifying, for each node of the plurality of nodes, a node type; and
means for modifying the transmission periodicity for the one or more messages based at least in part on the node density metric, or the node traffic pattern, or the node type for each node of the plurality of nodes, or a combination thereof.

30. A non-transitory computer-readable medium storing code for wireless communication at a user equipment (UE), the code comprising instructions executable by a processor to:
receive, from a first protocol layer of the UE, a channel occupancy ratio for each of one or more proximity service priority levels;
identify, by a second protocol layer of the UE, a resource availability metric and a message requirement metric for each of the one or more proximity service priority levels, the second protocol layer being a higher layer than the first protocol layer;
determine, by the second protocol layer of the UE, a message generation rate for each of the one or more proximity service priority levels based at least in part on the channel occupancy ratio, or the resource availability metric, or the message requirement metric, or a combination thereof; and
generate one or more messages for each of the one or more proximity service priority levels based at least in part on the message generation rate.

31. A non-transitory computer-readable medium storing code for wireless communication at a user equipment (UE), the code comprising instructions executable by a processor to:
identify a transmission periodicity of one or more messages of a proximity service priority level;
identify, for a plurality of nodes, a node density metric and a node traffic pattern;
identify, for each node of the plurality of nodes, a node type; and
modify the transmission periodicity for the one or more messages based at least in part on the node density metric, or the node traffic pattern, or the node type for each node of the plurality of nodes, or a combination thereof.
